(19) United States
(12) Patent Application Publication
(10) Pub. No.: US 2023/0019896 A1
(43) Pub. Date: Jan. 19, 2023

(54) ILLUMINATION DEVICE FOR A DISTANCE MEASUREMENT CAMERA SYSTEM, A CORRESPONDING ILLUMINATION METHOD AND A TOF CAMERA SYSTEM

(71) Applicant: TRUMPF Photonic Components GmbH, Ulm (DE)

(72) Inventor: Stephan Gronenborn, Aachen (DE)

(21) Appl. No.: 17/952,347

(22) Filed: Sep. 26, 2022

Related U.S. Application Data
(63) Continuation of application No. PCT/EP2021/058317, filed on Mar. 30, 2021.

(30) Foreign Application Priority Data
Mar. 31, 2020 (EP) 20167297.9

(51) Int. Cl. G01S 7/481; G01S 17/89

(52) U.S. Cl. CPC G01S 7/4815; G01S 17/89

(57) ABSTRACT

The present invention relates to an illumination device for a distance measurement camera, in particular a time of flight, TOF, camera system, a corresponding illumination method and a distance measurement camera system comprising said illumination device in order to improve distance measurements. The illumination device is configured to illuminate a particular region on an illumination plane with two different illumination profiles such as a first homogenous illumination profile and a second spot pattern illumination profile. The homogeneous illumination profile can enable a measurement with improved lateral resolution whereas the spot pattern illumination can enable a measurement with improved depth resolution.

### CROSS REFERENCE TO RELATED APPLICATIONS

This application is a continuation of International Application No. PCT/EP2021/058317 (WO 2021/198269 A1), filed on Mar. 30, 2021, and claims benefit to European Patent Application No. EP 20167297.9, filed on Mar. 31, 2020. The aforementioned applications are hereby incorporated by reference herein.

### FIELD

The present invention relates to an illumination device for a distance measurement camera system such as a time of flight, (TOF) camera system, a corresponding method and a distance measurement camera system comprising said illumination device.

### BACKGROUND

Distance measurement or ranging cameras such as time of flight (TOF) cameras measure depth in a scene and rely on illumination sources to illuminate objects, which are located in the field of view (FOV) of the capturing camera.

U.S. Pat. No. 8,761,594 B1 discloses systems and methods for providing spatially dynamic illumination in camera systems. A spatially dynamic illumination source shall enable the illumination of only desired objects in the field of view of the camera, thereby reducing the amount of light required from the illumination source. A spatially dynamic illumination source is provided that includes an array of illumination elements and a control component. Each illumination element in the illumination array includes a light-emitting element combined with an optical element. The control component allows controlling the illumination source to illuminate desired objects in the field of view of the camera. Each illumination element in the illumination array covers a particular different region of the field of view of the camera.

US 2017/356740 A1 discloses a curved array of light-emitting elements for sweeping out an angular range.

EP 3 451 470 A1 discloses a laser arrangement comprising a VCSEL array.

However, the currently available systems may not meet all requirements for different measurement applications.

### SUMMARY

In an embodiment, the present invention provides an illumination device for a distance measurement camera system, including an array of light emitting elements, wherein each light emitting element is configured to emit light to illuminate an illumination plane and wherein the array of light emitting elements comprises at least two groups of light emitting elements and an array of optical elements configured to affect the emitted light to affect the illumination in the illumination plane. The array of optical elements comprises at least two groups of different optical elements. A first group of optical elements is configured to affect the light emitted by a first group of light emitting elements and a second group of optical elements is configured to affect the light emitted by a second group of light emitting elements. The first group of optical elements is configured to affect the light differently from the second group of optical elements to illuminate a particular region on the illumination plane with two different illumination profiles. The first group of optical elements are diffusing optical elements adapted to diffuse light emitted by light emitting elements of the first group of light emitting elements, and the second group of optical elements are focusing optical elements adapted to focus light emitted light emitting elements of the second group of light emitting elements.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows schematically and exemplarily a distance measurement camera system according to an aspect of the present invention;

FIG. 2A shows schematically and exemplarily an illumination device adapted to illuminate an illumination plane homogenously;

FIG. 2B shows a schematic diagram of the illumination device shown in FIG. 2A adapted to illuminate the illumination plane by a spot pattern;

FIG. 3A shows a homogenous illumination profile in the illumination plane corresponding to the illumination shown in FIG. 2A;

FIG. 3B shows a spotted illumination profile in the illumination plane corresponding to the illumination shown in FIG. 2B;

FIG. 4 shows schematically and exemplarily a top view on an array of light emitting elements of the illumination device; and

FIG. 5 shows a schematic diagram exemplarily illustrating another embodiment of the illumination device.

### DETAILED DESCRIPTION

It is an object of the present invention to provide an improved light source for optical distance measurement. It would be advantageous to provide an improved illumination device and a corresponding method for illuminating the field of view of a distance measurement camera while also enabling highly accurate distance measurements. Further, it would be advantageous to provide a less complex, more cost-effective and/or smaller form factor illumination system. It is a further object of the present invention to provide a distance measurement camera system, in particular a TOF camera system, comprising said illumination device in order to allow the TOF camera system to measure distance with high accuracy.

In a first aspect of the present invention an illumination device for a distance measurement camera system, in particular a time-of-flight (TOF) camera system, is presented that comprises: an array of light emitting elements, wherein each light emitting element is configured to emit light to illuminate an illumination plane and wherein the array of light emitting elements comprises or is split into at least two groups of light emitting elements; and an array of optical elements configured to affect the emitted light to affect the illumination in the illumination plane;

wherein the array of optical elements comprises or is split into at least two groups of different optical elements,

wherein a first group of optical elements of said array of optical elements comprising the at least two groups of different optical elements is configured to affect the light emitted by a first group of light emitting elements of said array of light emitting elements comprising the at least two groups of light emitting elements and a second group of optical elements of said array of optical elements comprising the at least two groups of different optical elements is configured to affect the light emitted by a second group of light emitting elements of said array of light emitting elements comprising the at least two groups of light emitting elements,

wherein the first group of optical elements is configured to affect the light differently from the second group of optical elements to illuminate a particular region on the illumination plane with two different illumination profiles (such that a same surface element of the region can be selectively illuminated by the first group or by the second group), and

wherein the first group of optical elements are diffusing optical elements adapted to diffuse light emitted by light emitting elements of the first group of light emitting elements, and the second group of optical elements are focusing optical elements adapted to focus light emitted light emitting elements of the second group of light emitting elements.

In a further aspect of the present invention a corresponding illumination method is presented that comprises the steps of:
emitting light by an array of light emitting elements, wherein each light emitting element is configured to emit light to illuminate an illumination plane and wherein the array of light emitting elements comprises or is split into at least two groups of light emitting elements; and
affecting the emitted light by an array of optical elements to affect the illumination on the illumination plane;
wherein the array of optical elements comprises or is split into at least two groups of different optical elements,
wherein a first group of optical elements is configured to affect the light emitted by a first group of light emitting elements and a second group of optical elements is configured to affect the light emitted by a second group of light emitting elements,
wherein the first group of optical elements is configured to affect the light differently from the second group of optical elements to illuminate a particular region on the illumination plane with two different illumination profiles, and
wherein the first group of optical elements are diffusing optical elements adapted to diffuse light emitted by light emitting elements of the first group of light emitting elements, and the second group of optical elements are focusing optical elements adapted to focus light emitted light emitting elements of the second group of light emitting elements.

Preferred embodiments of the invention are defined in the dependent claims. It shall be understood that the claimed method has similar and/or identical preferred embodiments as the claimed device, in particular as defined in the dependent claims and as disclosed herein.

The present invention is based on the idea to provide a combined illumination device and a corresponding illumination method to create at least two different illumination profiles in an illumination plane. Said illumination device is preferably used for a distance measurement camera system such as a TOF camera system, which includes the illumination device, a (ranging) camera and an imaging element, such as a lens or a diffractive optical element (DOE), which is designed to image the illumination on said illumination plane onto the desired field of view of the TOF camera.

The present combined illumination device makes use of the advantages of using at least two different illumination profiles. For example, in a first mode of operation, a homogenous illumination may be provided by the first group of light emitting elements in combination with the first group of optical elements. In a second mode of operation, a spot pattern may be provided by the second group of light emitting elements in combination with the second group of optical elements. The same total energy that was previously used for homogeneous illumination may now be redistributed so as to bundle the irradiance in some pixels. Thus, more signal strength is gained in these few pixels while the other pixels are not used. This is advantageous, e.g., when illuminating objects far away from the TOF camera where the light source intensity must be higher than when illuminating objects close to the TOF camera to achieve the same signal-to-noise ratio. Hence, a better measurement accuracy of the distance or longer range compared to the standard approach at the cost of lateral resolution is achieved. Nonetheless, the same array with the different group can provide e.g. a homogeneous illumination that can still provide high lateral resolution at the cost of depth resolution. The proposed illumination device may thus provide a further improved flexibility and adaptability of providing a same particular region on an illumination plane with two different illumination profiles e.g. first illumination profile, such as a homogeneous illumination profile, adapted for distance measurement with high lateral resolution but limited depth resolution and a second illumination profile, such as a spot pattern illumination profile, adapted for distance measurement with reduced lateral resolution but high depth resolution. The proposed illumination device may realize a homogenous illumination as well as a spot pattern from the same semiconductor die in an intermediate plane.

Providing both groups of light emitting elements that are adapted, in combination with the respective groups of optical elements, to provide said different may provide advantages such as simplified manufacturing and also thermal advantages, e.g. regarding joint usage of cooling structures.

As indicated above, the present illumination device can be configured to combine different illumination profiles to provide an improved illumination device for TOF distance measurements. Hence, there is no need to provide one illumination device with optics to provide, e.g., a homogenous illumination, and another separate illumination device with optics to provide, e.g., a spot pattern of illumination as the present illumination device can be configured to provide both illumination profiles on its own. The same subsequent lens system may be used to image the different patterns provided in the intermediate plane onto the field of view. A synergy effect can thus be achieved.

The illumination device according to an aspect of the present invention comprises an array of light emitting elements, which is split into at least two groups of light emitting elements, namely at least a first group of light emitting elements and a second group of light emitting elements. The first group of light emitting elements and the second group of light emitting elements might also be called a first sub-array of light emitting elements and a second sub-array of light emitting elements.

Additionally, the illumination device comprises an array of optical elements, which is split into at least two groups of different optical elements. The at least two groups of different optical elements are at least split into a first group of optical elements and a second group of optical elements. The first group of optical elements and the second group of optical elements might also be called a first sub-array of optical elements and a second sub-array of optical elements.

The number of groups of light emitting elements and the number of groups of optical elements can be the same.

The first group of optical elements is configured to affect the light emitted by the first group of light emitting elements and the second group of optical elements is configured to affect the light emitted by the second group of light emitting elements. Further, the first group of optical elements is different from the second group of optical elements, which means that the first group of optical elements is configured to affect light differently from the second group of optical elements if the same kind of light passes through both groups of optical elements. Hence, one viable option might, e.g., be that one group of optical elements comprises convex optical lenses to focus light, whereas the other group of optical elements comprises concave optical lenses to diverge light. This allows that the particular region on the illumination plane is illuminated with two different illumination profiles.

A further advantage of the proposed solution can be that a less complex, more cost effective and/or smaller form factor illumination device for both flood and spot illumination can be provided.

It shall be understood that the present invention is not limited to two groups of light emitting elements and optical elements, respectively. Using even more groups provides the advantage that not only the key characteristics of two different illumination profiles can be combined, but of even more profiles to provide a more sophisticated illumination device for highly accurate TOF distance measurements.

Returning back to the example of two groups, respectively, the first kind of illumination profile might, e.g., be a flood illumination or a homogeneous illumination, whereas the second kind of illumination might, e.g., be a spot pattern, which comprises dots, stripes or circles. Using circles may provide the advantage that there may be more pixels in the dynamic range of the recording TOF camera compared to using dots, resulting in more noise reduction.

A particular region on the illumination plane, such as one specific pixel on said illumination plane, might thus be illuminated by a homogeneous illumination and additionally, when using the different group, by the spot pattern. Several pixels in the illumination plane are illuminated by both, the homogeneous illumination and the spot illumination. All pixels in the illumination plane illuminated by a spot pattern are preferably also illuminated by the homogeneous illumination profile.

The illumination plane can be arranged parallel to the array of light emitting elements and/or parallel to the array of optical elements. Further, the array of light emitting elements and the array of optical elements might be one-dimensional or two-dimensional arrays arranged parallel with respect to each other.

The first group of optical elements are diffusing optical elements adapted to diffuse light emitted by light emitting elements of the first group of light emitting elements. The second group of optical elements are focusing optical elements adapted to focus light emitted light emitting elements of the second group of light emitting elements. The optical elements of the first group can be defocusing optical elements adapted to diffuse light emitted by light emitting elements of the first group of light emitting elements. The optical elements of the first group can be optical elements adapted to increase a divergence angle of light emitted by the light emitting elements of the first group. The optical elements of the second group may for example create images of the light sources of the second group, for example images of VCSELs of the second group, at the illumination plane.

According to one embodiment, the light emitting elements can be vertical cavity surface emitting lasers (VCSELs) of the same type. All light emitting elements might be VCSELs configured to emit electromagnetic radiation in the red and/or infrared spectral range, but the present invention is not limited to the use of VCSELs. Other light emitting elements configured to emit narrow beams, i.e., narrow cones, might also work as well. Preferentially, infrared radiation may be used, which cannot be seen by a person, but can be detected by a camera, such as a TOF camera according to an aspect of the present invention. Hence, by using such an illumination device for a distance measurement camera system, the person/subject to be recorded by the distance measurement camera is not disturbed by the illumination. In general, using infrared light further ensures less signal disturbance and easier distinction from natural ambient light, resulting in high performance distance measurement sensing.

The light emitting elements of the first group can have a different size and/or shape than the light emitting elements of the second group. This can further support the provision of different illumination profiles. An advantage can be that the different illumination profiles can be even better tailored to a desired application scenario for the first and second illumination profiles.

As already explained above, the first group of optical elements can be adapted to provide a spot pattern of illumination on the illumination plane. The second group of optical elements can be adapted to provide a homogeneous or flood illumination in the illumination plane. The different optical elements can be diffractive optical elements (DOE), optical lenses or optical grids. If optical lenses are used, the first group of optical elements may comprise convex optical lenses to provide a spot pattern of illumination while the second group of optical elements may comprise concave optical lenses to provide a homogeneous illumination in the illumination plane.

The first group of optical elements can be adapted to affect the light of the first group of light emitting elements such that the illumination of one light emitting element intersects in the illumination plane with the illumination of a neighboring light emitting element. The neighboring light emitting element of one light emitting element can be a light emitting element belonging to the same group of light emitting elements and being located closest to the light emitting element with respect to the other light emitting elements of the same group. If the illumination of one light emitting element intersects in the illumination plane with the illumination of a neighboring light emitting element, a homogeneous illumination in the illumination plane can be ensured to provide a completely illuminated illumination plane without any gaps being not illuminated. In another embodiment, an integrated optics is added to each light emitting element of the first group of light emitting elements to widen the beam of each light emitting element such that they overlap earlier.

The second group of optical elements can be adapted to create at least one spot of illumination in the illumination plane resulting from emitted light of a plurality of light emitting elements belonging to the second group of light emitting elements. This embodiment has the advantage that if one light emitting element, such as one VCSEL, fails to emit electromagnetic radiation due to technical defects or aging, one particular spot or pixel in the illumination plane is still illuminated by the emitted light of other light emitting elements. Hence, one light emitting element can be acting as a backup light emitting element to compensate for the others failure.

The light emitting elements belonging to the first group of light emitting elements and the light emitting elements belonging to the second group of light emitting elements can be spatially intermixed. The light emitting elements belonging to the first group of light emitting elements and the light emitting elements belonging to the second group of light emitting elements can be arranged in an interleaved manner. Hence, the light emitting elements belonging to the first group of light emitting elements and the light emitting elements belonging to the second group of light emitting elements can be arranged in an interleaved arrangement of light emitting elements of the first group and light emitting elements of the second group. This embodiment may provide a compact design and/or advantageous heat distribution. For example if the first and second group are not activated at the same time, the interleaved arrangement may avoid an undue heating of neighboring light sources of the same group since a light source of the other group may be arranged therein between and provide thermal decoupling. A further advantage can be a compact design in particular in case where the optical elements of one of the first or second group may require more space than the optical elements of the respective other group. Hence, a higher density can be achieved which may result in lower chip area and thus lower cost as well as optionally increasing the yield due to lower device size

Accordingly, the optical elements belonging to the first group of optical elements and the optical elements belonging to the second group of optical elements can be spatially intermixed. The optical elements belonging to the first group of optical elements and the optical elements belonging to the second group of optical elements can be arranged in an interleaved arrangement of optical elements of the first group and optical elements of the second group. Optical elements of the first group of optical elements may have different footprint than optical elements of the second group of optical elements. For example, optical elements of the first group may be smaller or larger than optical elements of the second group. In case where the optical elements of one of the first or second group may require more space than the optical elements of the respective other group, the spatially intermixed or interleaved arrangement allows a compact design. This allows the use of a smaller array of light emitting elements, may reduce the chip size and thus lower cost as well as optionally increasing the yield.

In a refinement, the first group of optical elements is adapted to provide a homogenous illumination in the illumination plane and the second group of optical elements is adapted to provide a spot pattern of illumination in the illumination plane, wherein the optical elements of the first group and the optical elements of the second group are arranged in an interleaved arrangement; and wherein the optical elements of the first group have a different, in particular a smaller footprint, than the optical elements of the second group. For example, the first group may comprise smaller size diffusing optical elements, whereas the second group may comprise larger size focusing optical elements. Hence, a larger portion of the limited spatial resources can be allocated to an optical element for the spot pattern than to an optical element for the homogeneous illumination pattern. It has been found that such an imbalance may improve the quality of the spot pattern while still providing a sufficient quality for the homogeneous illumination pattern.

The optical elements can be lenses. The optical elements of the first group of optical elements can have a different focal length than the optical elements of the second group of optical elements. An advantage is that the different illumination profiles such as a focused spot pattern and a defocused homogeneous illumination patter may be provided with a similar type of optical element, wherein a parameter of the optical element such as the focal length is varied. This may simplify the manufacturing process. A lens as used herein may also include meta-lenses or other lens-like structures, including segmented lenses such as Fresnel lenses.

The optical elements may be integrally formed with the light emitting elements to provide a compact and space-saving illumination device. This might, e.g., be achieved by 3D laser lithography, where optical elements, such as optical lenses, are directly manufactured on top of a VCSEL array. Preferably, said configuration can be achieved by arranging the optical elements and the light emitting elements on the surface of a semiconductor die.

At least one group of optical elements may comprise optical elements which are each configured to affect the light of one light emitting element to realize a multiple spot pattern of illumination in the illumination plane. Hence, not only one sharp dot per light emitting element is created, but even a multiple spot pattern per light emitting element may be created.

The light emitting elements belonging to the same group of light emitting elements can be arranged regularly, in particular on a quadratic, rectangular, circular or a hexagonal lattice. Alternatively, the light emitting elements belonging to the same group of light emitting elements might also be arranged randomly to create a random spot pattern. If the light emitting elements belonging to the same group of light emitting elements are arranged regularly, the light emitting elements might further be equidistantly arranged with respect to each other to create a regular pattern of illumination in the illumination plane. The arrangement on a quadratic, hexagonal or circular lattice results in a regular illumination on the illumination plane that has the shape of a quadrat, hexagon or circle. A random spot pattern may also be created by shifting the illumination spots in the illumination plane by affecting the light such by the second group of optical elements.

The illumination device can comprise a control unit. This control unit can be configured to control the illumination of the array of light emitting elements, wherein the illumination of the first group of light emitting elements and the illumination of the second group of light emitting elements is controlled separately, in particular alternately. Preferably, the control unit is configured to electronically drive the light emitting elements by actuating the different groups of light emitting elements in alternation so as to generate either a homogeneous illumination or a spotted illumination.

As an alternative to time-of-flight, the distance measurement camera system may also use a different distance measurement principle such as triangulation or structured light. For example, a structured light pattern may be projected onto a scene and imaged by a conventional 2D camera. The illumination device may be arranged at an angle with respect to the camera such that a distance can be determined based on the distance between camera and illumination device, the angle of projection to the light emitted by the illumination device with respect the camera and the displacement of the light in the field of view of the camera. It shall be understood that, even though examples of the present disclosure are described for TOF, the same considerations can apply to a triangulation or structured light based distance measurement.

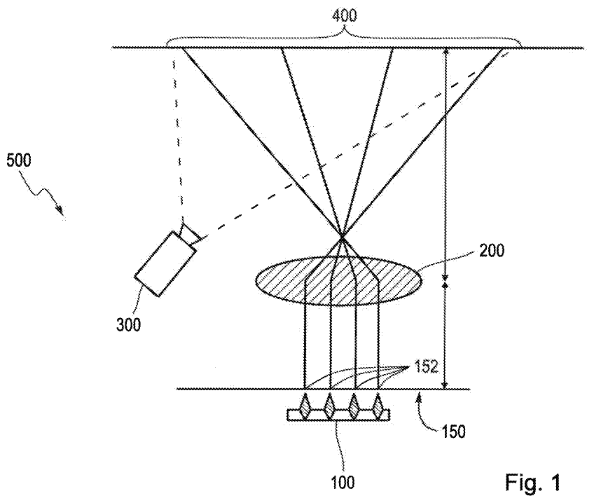

FIG. 1 shows schematically and exemplary distance measurement or ranging camera system 500 according to an aspect of the present disclosure. The distance measurement camera system 500 can be a time-of-flight, TOF, camera system or structured light or triangulation-based distance measurement camera system. In the following example, reference will be made to a TOF camera system.

The TOF camera system 500 comprises a TOF camera receiver 300, an illumination device 100 and a projection element 200. The TOF camera receiver 300 is a ranging imaging camera that employs TOF sensing techniques to resolve the distance between the TOF camera receiver 300 and an object (not shown in FIG. 1) located in the field of view (FOV) 400 of the TOF camera receiver 300 based on the round-trip time of light emitted by the illumination device to a target in the field of view 400 and then received by the TOF camera receiver 300. The illumination device 100 is configured to illuminate an intermediate or illumination plane 150 with a certain illumination profile. According to the exemplary embodiment shown in FIG. 1, the illumination device 100 is configured to illuminate the illumination plane 150 by a spot illumination pattern comprising a plurality of dots 152 to be illuminated in the illumination plane 150. It will become apparent from the subsequent figures that the illumination device 100 is not only configured to illuminate the illumination plane 150 by a spot pattern, but also, e.g., by a homogeneous illumination.

The projection element 200 is configured to project the illumination in the illumination plane 150 to the desired field of view 400 of the TOF camera 300. Thus, the imaging plane 150 is preferably located in the front focal plane of the projection element 200.

As TOF is a method for measuring the distance between a sensor, such as the camera receiver 300, and an object, based on the time difference between the emission of a signal and its return to the sensor, after being reflected by an object located in the field of view of the sensor, the illumination device 100 and the camera receiver 300 are typically integrally formed in the same device. For purposes of illustration only, the TOF camera receiver 300 and the illumination device 150 are not integrally formed in one device in FIG. 1 to more clearly express the different single constituents of the TOF camera system 500.

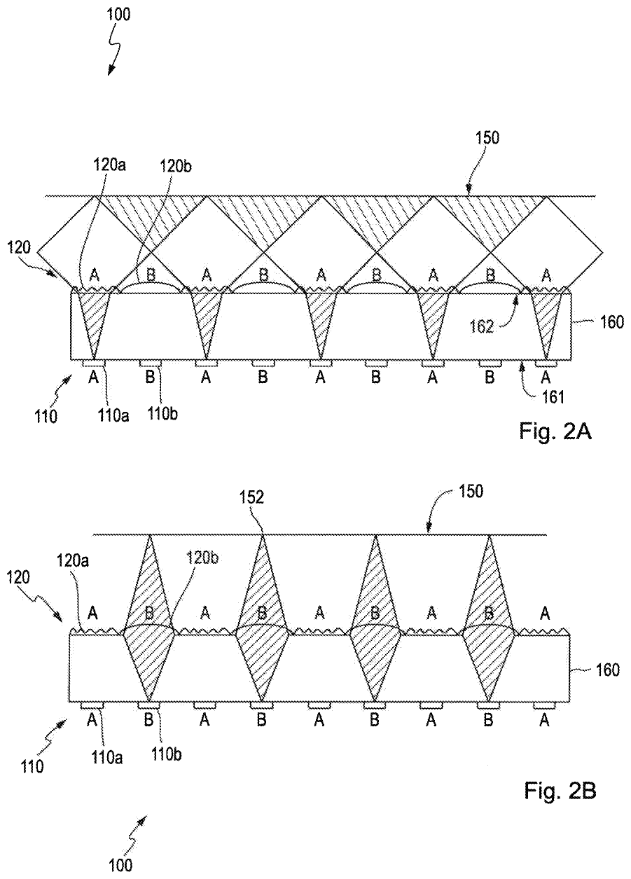

FIG. 2A shows schematically and exemplarily the illumination device 100 according to one embodiment of the present invention. Said illumination device 100 is configured to illuminate the illumination plane 150 homogeneously in a first mode of operation. The illumination device 100 comprises an array of light emitting elements 110. The array of light emitting elements 110 is split into at least two groups of light emitting elements. Exemplarily, two groups, a first group of light emitting elements 110A and a second group of light emitting elements 110B are shown. The first group of light emitting elements 110A comprises a plurality of light emitting elements 110a and the second group of light emitting elements 110B comprises a plurality of light emitting elements 110b. Each light emitting element 110a, 110b of said array is configured to emit light to illuminate the illumination plane 150. The emitted light of the light emitting elements 110b belonging to the second group of light emitting elements 110B is explained in more detail with reference to FIG. 2B below.

The array of light emitting elements 110 can be a two-dimensional array or also a one-dimensional array. As shown in FIG. 2A, the array of light emitting elements 110 may be arranged on a first surface 161 of a semiconductor die 160. The semiconductor die 160 can be transparent to electromagnetic radiation in the red and infrared spectral range. The light emitting elements 110a, 110b might be VCSELs of the same type grown or deposited on said surface 161 of the semiconductor die 160. The VCSELs may be bottom-emitters configured to emit the electromagnetic radiation into and through the semiconductor die 160 as illustrated in FIG. 2A and 2B.

The light emitting elements 110a belonging to the first group of light emitting elements 110A and the light emitting elements 110b belonging to the second group of light emitting elements 110B are preferably spatially intermixed or even arranged in an interleaved arrangement. The configuration of the array of light emitting elements 110 shown in FIG. 2A comprises light emitting elements 110a, 110b which are equidistantly arranged with respect to each other to create a regular illumination on the illumination plane 150. Optionally, the light emitting elements 110a of the first group may be configured to emit light with a different divergence angle than the light emitting elements 110b of the second group.

The illumination device 100 further comprises an array of optical elements 120, which is configured to affect the light emitted by the array of light emitting elements 110 and is arranged on a second surface 162 of the semiconductor die 160 opposite to the first surface 161 on which the array of light emitting elements 110 is arranged. The illumination in the illumination plane 150 is affected by said array of optical elements 120, which affects the electromagnetic radiation emitted by the light emitting elements 110a, 110b and passed-through the transparent semiconductor die 160.

The array of optical elements 120 is split into two groups of different optical elements 120A, 120B, wherein the first group of optical elements 120A is configured to affect the light emitted by the first group of light emitting elements 110A as shown in FIG. 2A. The second group of optical elements 120B is configured to affect the light emitted by the second group of light emitting elements 110B as shown in FIG. 2B. FIG. 2B shows a schematic diagram of the same illumination device 100 which is shown in FIG. 2A. In contrast to FIG. 2A, FIG. 2B shows a configuration of the illumination device 100 where a spot pattern of illumination instead of a homogenous illumination is created in the illumination plane 150.

A particular region on the illumination plane 150 can thus illuminated with two different illumination profiles. This becomes apparent by comparing FIGS. 2A and 2B. A particular region on the illumination plane 150, such as a specific pixel 152 on said illumination plane 150, may be illuminated with two different illumination profiles, such as a spot as shown in FIG. 2B or by a homogenous illumination as shown in FIG. 2A.

The optical elements 120a belonging to the first group of optical elements 120A may be optical lenses, an optical grid, meta-lenses or diffractive optical elements (DOE). Exemplarily, the optical elements 120a of the first group of optical elements 120A as shown in FIG. 2A are be diverging Fresnel lenses or diffusor optical elements. The first group of optical elements 120A affects the light of the first group of light emitting elements 110A such that the illumination of one light emitting element 110a belonging to the first group of light emitting elements 110A intersects in the illumination plane 150 with the illumination resulting from the emitted light of a neighboring light emitting element 110a belonging to the same group of light emitting elements 110A. The neighboring light emitting element of one light emitting element is the light emitting element belonging to the same group of light emitting elements and is located closest to the light emitting element with respect to the other light emitting elements belonging to the same group. For example, the first group of optical elements may be adapted to provide a homogeneous illumination in the plane 150.

In an advantageous embodiment, the illumination of one light emitting element 110a belonging to the first group of light emitting elements 110A does not only intersect in the illumination plane 150 with the illumination resulting from the emitted light of a direct neighboring light emitting element 110a, but even with the illumination resulting from emitted light of the second, third or fourth neighboring light emitting element 110a. This may provide an even more homogenous illumination in the illumination plane 150. Further, if one light emitting element 110a fails, a homogenous illumination profile in the illumination plane 150 is not destroyed due to the intersection of the plurality of single illumination profiles.

The optical elements 120b belonging to the second group of optical elements 120B may be optical lenses, an optical grid, meta-lenses or diffractive optical elements (DOE). Exemplarily, the optical elements 120b can be spherical optical lenses as illustrated in FIG. 2B, but may also be aspherical optical lenses. It is shown in FIG. 2B that each spot in the illumination plane 150 results from the light emitted from one specific light emitting element 110b belonging to the second group of light emitting elements 110B. However, the second group of optical elements 120B might also be adapted to create at least one spot of illumination in the illumination plane 150 resulting from emitted light from a plurality of light emitting elements 110b belonging to the second group of light emitting elements 110B. This might be implemented such for redundancy purposes if one light emitting element 110b fails.

The configuration shown in FIG. 2B, the second group of optical elements 120B might also comprise optical elements 120b which are each configured to affect the light of one light emitting element 110b to realize multiple spots and not only a single spot of illumination in the illumination plane 150 resulting from the emitted light of one light emitting element 110b belonging to the second group of light emitting elements 110B.

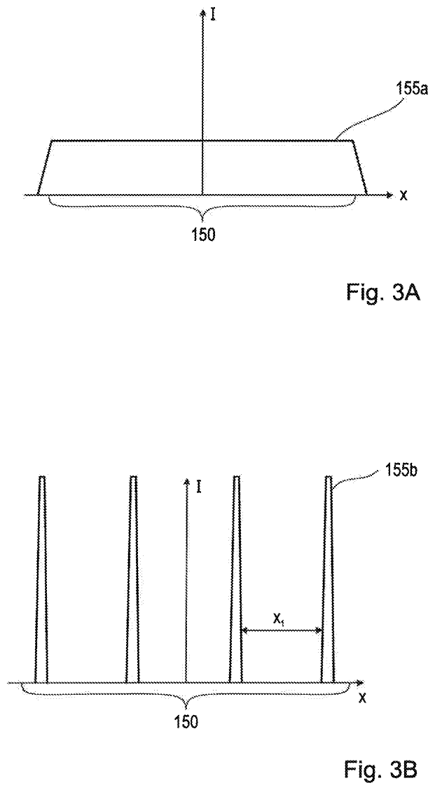

FIG. 3A shows a homogenous illumination profile 155a in the illumination plane 150 corresponding to the illumination shown in FIG. 2A. The illumination profile 155a is represented by a function I(x), which represents the intensity of illumination in dependence on the lateral extension of the illumination plane 150. The intersection of the single illuminations resulting from the light emitted from the single light emitting elements 110a as shown in FIG. 2A can result in a homogenously distributed illumination profile 155a with a small slope at the outside. Said homogenous illumination profile 155a may be projected onto the field of view 400 of the TOF camera 300 by using the projection element 200 as shown in FIG. 1.

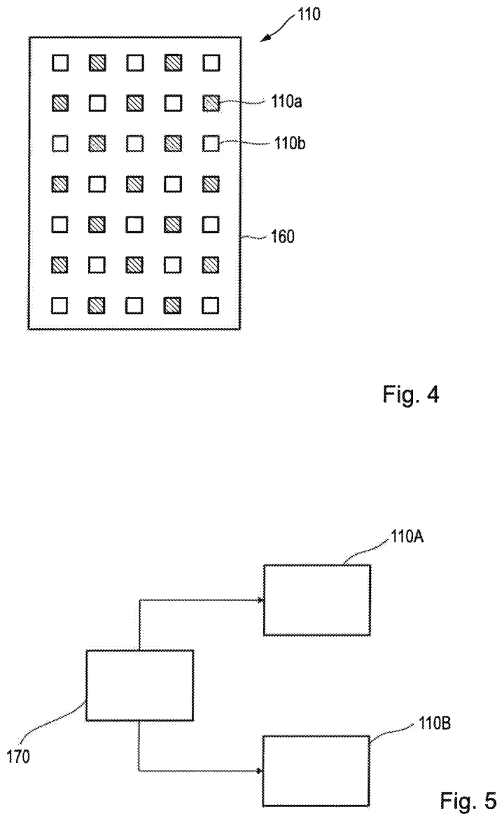

FIG. 3B shows a spot illumination profile 155b in the illumination plane 150 corresponding to the illumination shown in FIG. 2B, wherein the spot illumination profile 155b is again represented by a function I(x). Said exemplarily illustration results from a regular arrangement of the light emitting elements 110b shown in FIG. 2B as the illumination profile 155b and may comprise a plurality of blurred delta functions each representing one spot of illumination in the illumination plane 150. Further, the light emitting elements 110b may be equidistantly arranged with respect to each other to achieve the regular spotted illumination profile 155b as all delta functions have the same distance xi in FIG. 3B. Such a configuration of the array of light emitting elements 110 is schematically and exemplarily shown in FIG. 4.

Preferably, all light emitting elements 110a, 110b are VCSELs of the same type configured to emit electromagnetic radiation with the same power. As the array of light emitting elements 110 is split into a first group of light emitting elements 110A and a second group of light emitting elements 110B and as both groups 110A, 110B preferably comprise the same amount of VCSELs as shown in FIGS. 2A and 2B, the area under the functions I(x) shown in FIGS. 3A and 3B are preferably the same. Hence, the illumination plane 150 can either be homogenously illuminated as shown in FIG. 3A or illuminated by a spot pattern with the same total energy.

FIG. 5 shows a schematic diagram of an illumination device comprising a control unit 170. The control unit 170 configured to control the illumination of the array of light emitting elements 110 such that the illumination of the first group of light emitting elements 110A and the illumination of the second group of light emitting elements 110B is controlled separately. By activating the first group of light emitting elements 110A a homogeneous illumination may be provided illumination plane 150. By activating the second group of light emitting elements 110B a spot pattern illumination may be provided illumination plane 150. Hence, the specific illumination profiles 155a, 155b as shown in FIG. 3A and B can be controlled efficiently.

Preferably, the control unit 170 is configured to electronically drive the first group of light emitting elements 110A and the second group of light emitting elements 110B in an alternate manner. In a first step, the control unit 170 might electronically switch on the first group of light emitting elements 110A to illuminate the illumination plane 150 by a homogenous illumination. Subsequently, in a second step, the control unit 170 might switch on the second group of light emitting elements 110B to illuminate the illumination plane 150 by a spot pattern while additionally switching off the second group of light emitting elements 110B. Hence, by using the illumination device 100 for a TOF camera system 500 as shown in FIG. 1, TOF distance measurements of an object located in the field of view 400 of the TOF camera 300 might be first recorded by using a homogenous illumination and might be subsequently recorded by using a spot pattern of illumination. Thus, the present invention allows efficiently combining the results of TOF measurements with different illumination profiles by just using one illumination device 100. More accurate TOF distance measurements compared to performing TOF distance measurements with only one illumination profile may thus be obtained. The advantages of using the respective different illumination profiles, such as the higher lateral resolution obtained by using a homogenous illumination and the better accuracy or depth resolution for the measurement of the distance between an object and the TOF camera 300 by using a spot pattern of illumination, can be efficiently combined.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An illumination device for a distance measurement camera system, the illumination device comprising:
an array of light emitting elements, wherein each light emitting element is configured to emit light to illuminate an illumination plane and wherein the array of light emitting elements comprises at least two groups of light emitting elements; and
an array of optical elements configured to affect the emitted light to affect the illumination in the illumination plane,
wherein the array of optical elements comprises at least two groups of different optical elements,
wherein a first group of optical elements is configured to affect the light emitted by a first group of light emitting elements and a second group of optical elements is configured to affect the light emitted by a second group of light emitting elements, and
wherein the first group of optical elements is configured to affect the light differently from the second group of optical elements to illuminate a particular region on the illumination plane with two different illumination profiles
wherein the first group of optical elements are diffusing optical elements adapted to diffuse light emitted by light emitting elements of the first group of light emitting elements, and the second group of optical elements are focusing optical elements adapted to focus light emitted light emitting elements of the second group of light emitting elements.

2. The illumination device according to claim 1,
wherein the light emitting elements are vertical cavity surface emitting lasers, VCSELs, of the same type.

3. The illumination device according to claim 1, wherein the light emitting elements of the first group have a different size and/or shape than the light emitting elements of the second group.

4. The illumination device according to claim 1,
wherein the first group of optical elements is configured to provide a homogenous illumination in the illumination plane, and
the second group of optical elements is configured to provide a spot pattern of illumination in the illumination plane.

5. The illumination device according to claim 4,
wherein the first group of optical elements is adapted to affect the light of the first group of light emitting elements such that an illumination of one light emitting element belonging to the first group of light emitting elements intersects in the illumination plane with an illumination of a neighboring light emitting element belonging to the same group of light emitting elements; or
wherein the second group of optical elements is configured to create at least one spot of illumination in the illumination plane resulting from emitted light of a plurality of light emitting elements belonging to the second group of light emitting elements.

6. The illumination device according to claim 1,
wherein the optical elements belonging to the first group of optical elements and the optical elements belonging to the second group of optical elements are spatially intermixed.

7. The illumination device according to claim 6,
wherein the optical elements belonging to the first group of optical elements and the optical elements belonging to the second group of optical elements are arranged in an interleaved arrangement of optical elements of the first group and optical elements of the second group.

8. The illumination device according to claim 6,
wherein the optical elements of the first group of optical elements have a different footprint than the optical elements of the second group of optical elements.

9. The illumination device according to claim 1, wherein the optical elements are lenses and wherein the optical elements of the first group of optical elements have a different focal length than the optical elements of the second group of optical elements.

10. The illumination device according to claim 1,
wherein the optical elements are integrally formed with the light emitting elements.

11. The illumination device according to claim 1, wherein at least one group of optical elements comprises optical elements which are each configured to affect the light of one light emitting element to realize a multiple-spot pattern of illumination in the illumination plane.

12. The illumination device according to claim 1, further comprising:
a control unit configured to control the illumination of the array of light emitting elements, wherein the illumination of the first group of light emitting elements and the illumination of the second group of light emitting elements is controlled separately.

13. The illumination device as recited in claim 1, wherein the camera system includes a time of flight (TOF) camera system.

14. A distance measurement camera system, comprising the illumination device according to claim 1, a camera and an imaging element, wherein the illumination plane is arranged between the array of light emitting elements and a field of view, (FOV), of the camera and the imaging element is configured to image the illumination on the illumination plane onto the FOV of the camera.

15. An illumination method comprising the steps of:
emitting light by an array of light emitting elements, wherein each light emitting element is configured to emit light to illuminate an illumination plane and wherein the array of light emitting elements comprises at least two groups of light emitting elements; and
affecting the emitted light by an array of optical elements to affect the illumination on the illumination plane,
wherein the array of optical elements comprises at least two groups of different optical elements,
wherein a first group of optical elements is configured to affect the light emitted by a first group of light emitting elements and a second group of optical elements is configured to affect the light emitted by a second group of light emitting elements, and
wherein the first group of optical elements is configured to affect the light differently from the second group of optical elements to illuminate a particular region on the illumination plane with two different illumination profiles
wherein the first group of optical elements are diffusing optical elements adapted to diffuse light emitted by light emitting elements of the first group of light emitting elements, and the second group of optical elements are focusing optical elements adapted to focus light emitted light emitting elements of the second group of light emitting elements.
